(19) United States
(12) Patent Application Publication
(10) Pub. No.: US 2018/0286408 A1
(43) Pub. Date: Oct. 4, 2018

(54) INFORMATION PROCESSING APPARATUS, INFORMATION PROCESSING METHOD, AND INFORMATION PROCESSING PROGRAM

(71) Applicant: NEC Corporation, Tokyo (JP)

(72) Inventor: Mitsunori MORISAKI, Tokyo (JP)

(73) Assignee: NEC Corporation, Tokyo (JP)

(21) Appl. No.: 15/924,671

(22) Filed: Mar. 19, 2018

(30) Foreign Application Priority Data
Mar. 31, 2017 (JP) 2017-070464

(51) Int. Cl. G10L 17/00; G10L 17/06; G10L 21/0316; G10L 15/22

(52) U.S. Cl. CPC G10L 17/005; G10L 17/06; G10L 2015/223; G10L 15/22; G10L 21/0316

(57) ABSTRACT

Conference voices input from one terminal are processed to provide a higher voice quality for a listener of conference contents. There is provided a conference voice processing apparatus that includes a conference voice analyzer that extracts individual voice data of at least two speakers from input voice data input to a conference voice input terminal, a speaker notifier that notifies a user terminal of the at least two speakers included in the input voice data, an instruction acquirer that acquires, from the user terminal, a selection instruction of at least one speaker included in the at least two speakers notified by the speaker notifier, and a voice controller that controls individual voice data corresponding to the selected speaker and outputs the controlled data to the user terminal.

### CROSS-REFERENCE TO RELATED APPLICATION

This application is based upon and claims the benefit of priority from Japanese patent application No. 2017-070464, filed on Mar. 31, 2017, the disclosure of which is incorporated herein in its entirety by reference.

### BACKGROUND OF THE INVENTION

### Field of the Invention

The present invention relates to an information processing apparatus, an information processing method, and an information processing program.

### Description of the Related Art

In the above technical field, patent literature 1 discloses a technique of receiving, by a communication processor, voices of a plurality of participants collected by microphones of a plurality of terminals and reducing the volume of or blocking voices input from terminals other than a specified terminal.

[Patent Literature 1] Japanese Patent Laid-Open No. 2015-046822

### SUMMARY OF THE INVENTION

In the technique described in the above literature, however, it is impossible to control a specific sound from voices of a plurality of persons collected by one terminal.

The present invention enables to provide a technique of solving the above-described problem.

One example aspect of the present invention provides a conference voice processing apparatus, the apparatus comprising:

a conference voice analyzer that extracts individual voice data of at least two speakers from input voice data input from a conference voice input terminal;

a speaker notifier that notifies a user terminal of the at least two speakers included in the input voice data;

an instruction acquirer that acquires, from the user terminal, a selection instruction of at least one speaker included in the at least two speakers notified by the speaker notifier; and

a voice controller that controls individual voice data corresponding to the selected speaker and outputs the controlled data to the user terminal.

Another example aspect of the present invention provides a conference voice processing apparatus, the apparatus comprising:

a microphone that inputs conference voices;

a conference voice analyzer that extracts individual voice data of at least two speakers from input voice data;

a speaker notifier that notifies a user terminal of the at least two speakers included in the input voice data;

an instruction acquirer that acquires, from the user terminal, a selection instruction of at least one speaker included in the at least two speakers notified by the speaker notifier; and

a voice controller that controls individual voice data corresponding to the selected speaker and outputs the controlled data to the user terminal.

Still other example aspect of the present invention provides a conference voice processing method, the method comprising:

extracting individual voice data of at least two speakers from input voice data input from a conference voice input terminal;

notifying a user terminal of the at least two speakers included in the input voice data;

acquiring, from the user terminal, a selection instruction of at least one speaker included in the at least two speakers notified in the notifying; and

controlling individual voice data corresponding to the selected speaker and outputting the controlled data to the user terminal.

Still other example aspect of the present invention provides a conference voice processing program for causing a computer to execute a method, comprising:

extracting individual voice data of at least two speakers from input voice data input from a conference voice input terminal;

notifying a user terminal of the at least two speakers included in the input voice data;

acquiring, from the user terminal, a selection instruction of at least one speaker included in the at least two speakers notified in the notifying; and

controlling individual voice data corresponding to the selected speaker and outputting the controlled data to the user terminal.

According to the present invention, it is possible to process conference voices input from one terminal and provide a higher voice quality for a listener of conference contents.

### BRIEF DESCRIPTION OF THE DRAWINGS

FIG. 1 is a block diagram showing the arrangement of a conference voice processing apparatus according to the first example embodiment of the present invention;

FIG. 2 is a view for explaining an effect of a conference voice processing apparatus according to the second example embodiment of the present invention;

FIG. 3 is a view for explaining the effect of the conference voice processing apparatus according to the second example embodiment of the present invention;

FIG. 4 is a block diagram showing the functional arrangement of the conference voice processing apparatus according to the second example embodiment of the present invention;

FIG. 5 is a view showing a display screen example of a user terminal included in a conference voice processing system according to the second example embodiment of the present invention;

FIG. 6 is a table showing the arrangement of a speaker database used in the conference voice processing apparatus according to the second example embodiment of the present invention;

FIG. 7 is a flowchart showing a processing sequence in the conference voice processing apparatus according to the second example embodiment of the present invention;

FIG. 8 is a flowchart showing a processing sequence in the conference voice processing apparatus according to the second example embodiment of the present invention;

FIG. 9 is a block diagram showing the functional arrangement of a conference voice processing apparatus according to the third example embodiment of the present invention;

FIG. 10 is a block diagram showing the functional arrangement of a conference voice processing apparatus according to the fourth example embodiment of the present invention;

FIG. 11 is a view showing a display screen example of a user terminal included in a conference voice processing system according to the fifth example embodiment of the present invention; and

FIG. 12 is a view showing a display screen example of a user terminal included in a conference voice processing system according to the sixth example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

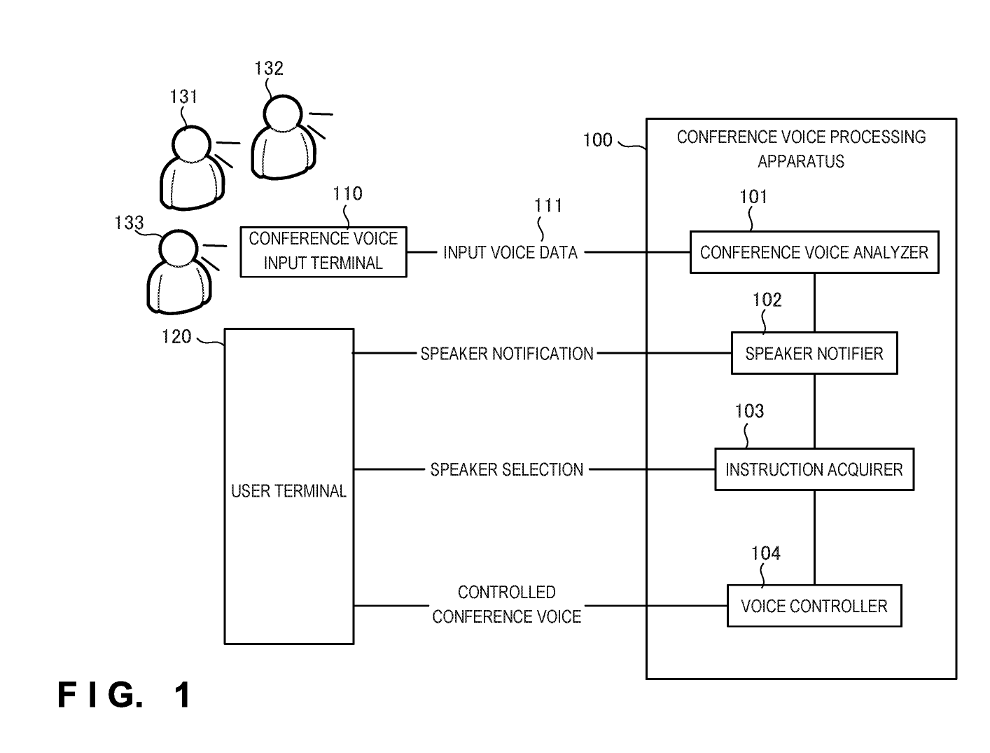

A conference voice processing apparatus 100 as the first example embodiment of the present invention will be described with reference to FIG. 1. The conference voice processing apparatus 100 includes a conference voice analyzer 101, a speaker notifier 102, an instruction acquirer 103, and a voice controller 104.

The conference voice analyzer 101 extracts individual voice data of at least two out of speakers 131 to 133 from input voice data 111 input from a conference voice input terminal 110.

The speaker notifier 102 notifies a user terminal 120 of at least two out of the speakers 131 to 133 included in the input voice data 111.

The instruction acquirer 103 acquires, from the user terminal 120, a selection instruction of the at least one speaker 133 included in at least two out of the speakers 131 to 133 notified by the speaker notifier 102.

The voice controller 104 controls individual voice data corresponding to the selected speaker 133 and outputs the controlled data to the user terminal.

According to the above arrangement, it is possible to control voice data by selecting a speaker who is included in conference voices input from one terminal, making it possible to provide a higher voice quality for a listener of conference contents. Note that the conference voice analyzer 101 may specify/separate a speaker by analyzing his/her voice print, or specify/separate the speaker by a process of analyzing a sound source direction using a microphone array or the like.

### Second Example Embodiment

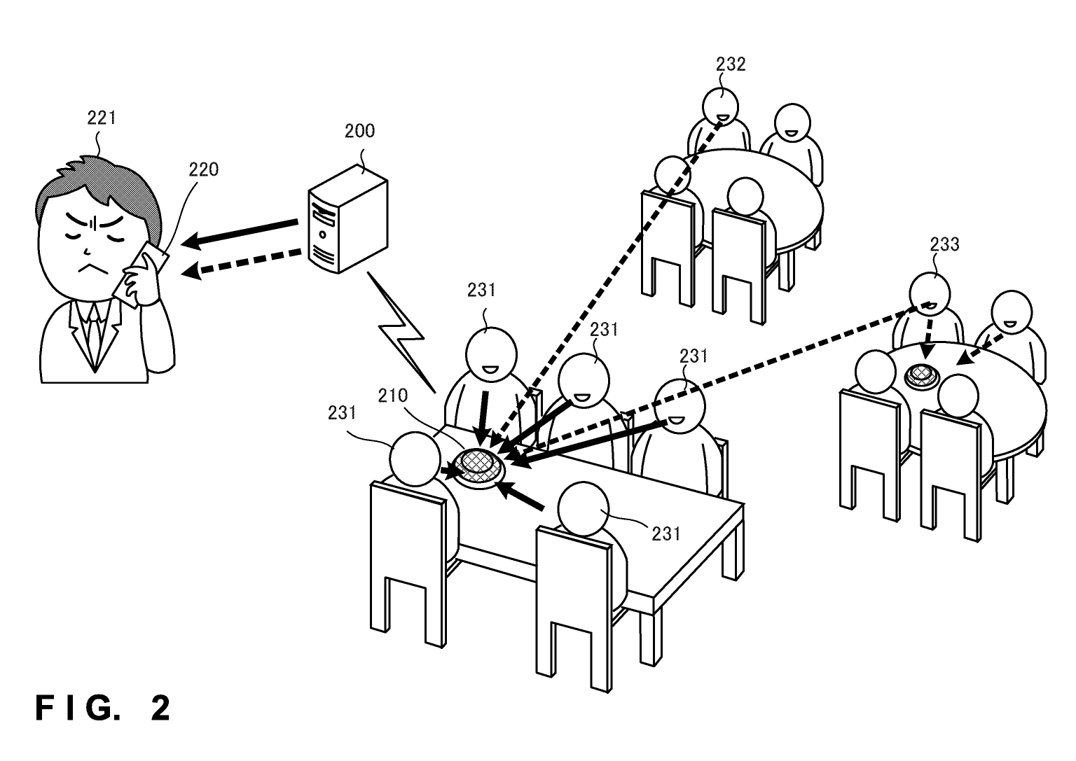

A conference voice processing apparatus according to the second example embodiment of the present invention will be described next with reference to FIG. 2. FIG. 2 is a view for explaining a method for using a conference voice processing apparatus 200 according to this example embodiment.

A conference is taken place while a plurality of conference participants input voices to a conference voice input terminal 210 as speakers 231. On the other hand, a user 221 uses a user terminal 220 as a communication terminal such as a smartphone or the like to listen to conference contents in a remote place and make an utterance as needed.

For example, if the conference voice processing apparatus 200 does not perform any process, the conference voice input terminal 210 picks up voices of speakers 232 and 233 each making an utterance at a table near the conference voice input terminal 210, causing a situation in which the user 221 has difficulty in hearing voices of the speakers 231.

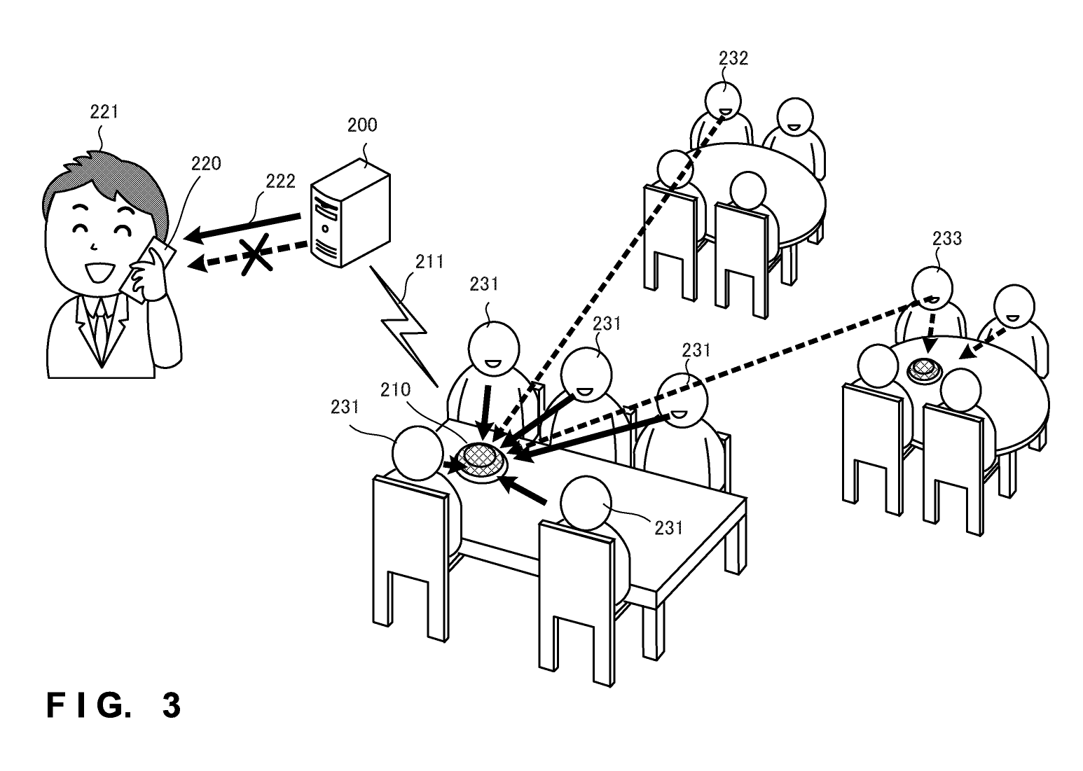

To cope with this, in this example embodiment, as shown in FIG. 3, the conference voice processing apparatus 200 eliminates voices of the speakers 232 and 233 that are unnecessary for the user 211 from input voice data 211, providing conference voices 222 of higher quality for the user 221.

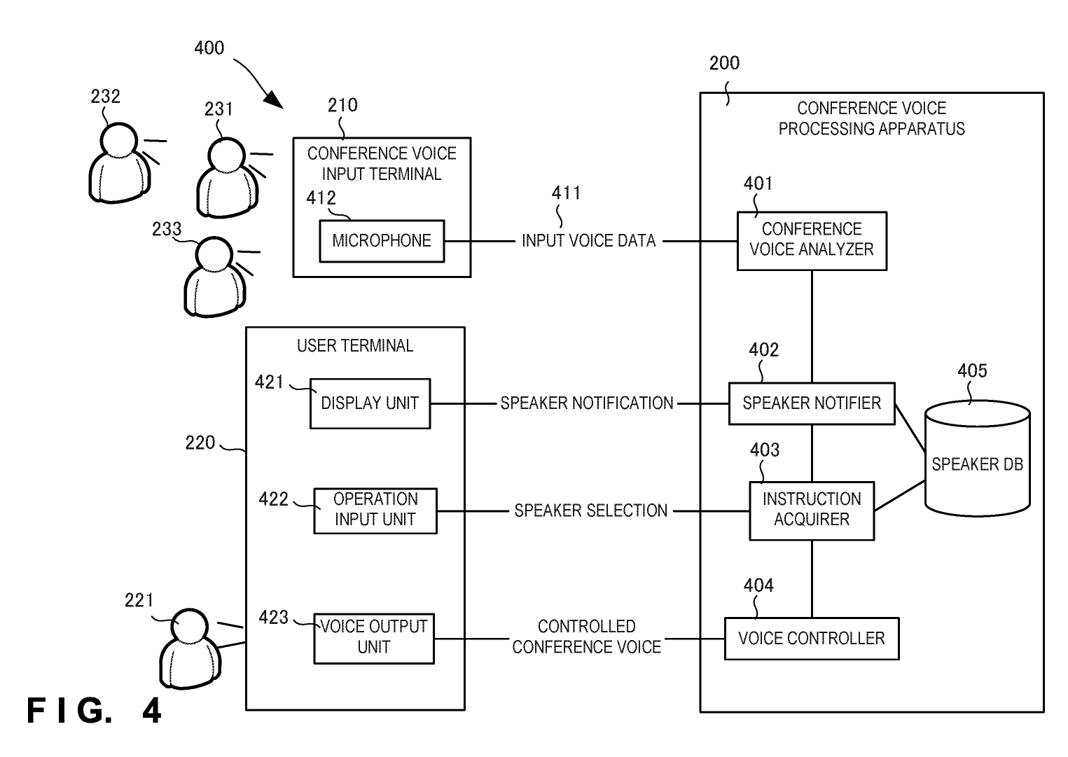

FIG. 4 is a block diagram showing the functional arrangement of a conference system 400 including the conference voice processing apparatus 200.

The conference voice input terminal 210 includes a microphone 412, receives voices uttered by the plurality of speakers 231 to 233, and transmits them to the conference voice processing apparatus 200 as input voice data 411.

The conference voice processing apparatus 200 includes a conference voice analyzer 401, a speaker notifier 402, an instruction acquirer 403, a voice controller 404, and a speaker database 405 and performs information communication with the user terminal 220. The user terminal 220 includes a display unit 421, an operation input unit 422, and a voice output unit 423.

The conference voice analyzer 401 performs voice print analysis processing on the input voice data 411 input from the conference voice input terminal 210 and extracts individual voice data of at least two out of the speakers 231 to 233.

The speaker notifier 402 notifies the user terminal 220 of at least two out of the speakers 231 to 233 included in the input voice data 411. The user terminal 220 displays identification images indicating the speakers 231 to 233 on the display unit 421. The speaker notifier 402 notifies the user terminal 220 of the speaker for each predetermined period, and the user terminal 220 updates the identification image on the display unit 421 as needed. Consequently, a speaker who does not utter for a predetermined period or more is no longer displayed. Voice print information of the speaker recognized once is registered in the speaker database 405 as a voice print database.

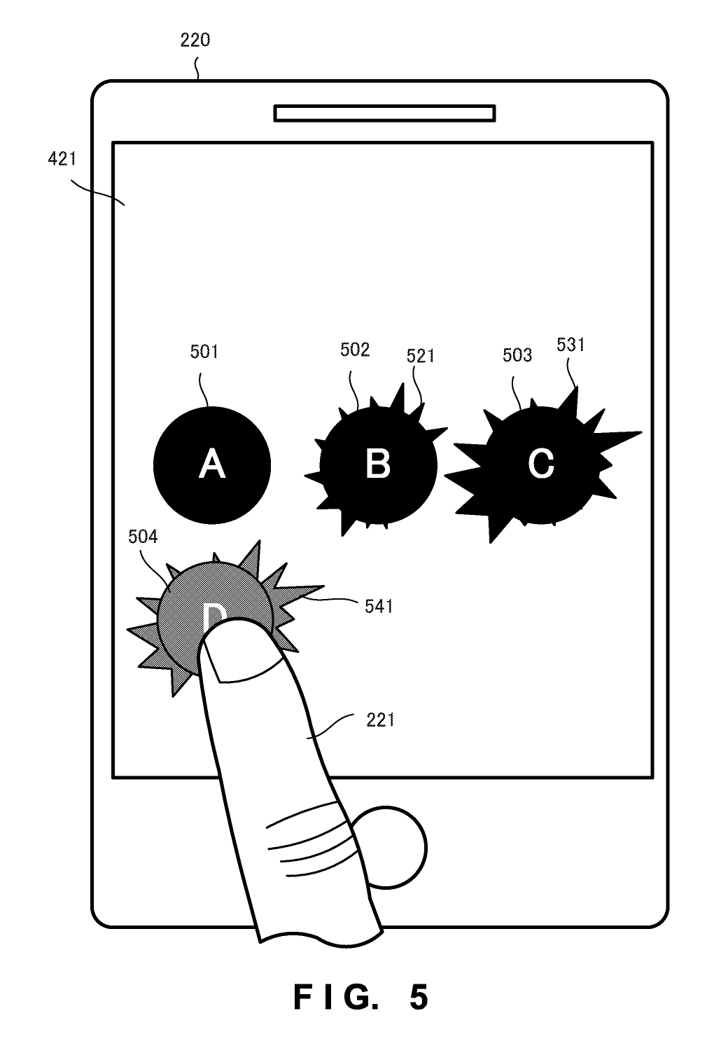

FIG. 5 shows a display screen example in the user terminal 220. As shown in FIG. 5, circular icons 501 to 504 are shown as identification images indicating speakers on the display unit 421. Spines 521 to 541 around the icons 502 to 504 indicate utterance situations, and largely protruding spines are displayed as volume increases. The expression of the volume is not limited to this, and the icons may vibrate or may change their colors depending on the volume. The names (anonyms if their voice prints cannot be collated even with reference to the speaker database 405) of the speakers are shown as speaker identification information inside the icons 501 to 504. The display of FIG. 5 indicates that A little utters, and B, C, and D utter. In particular, C speaks with a loud voice. If the user 221 taps the icon 504 of D in this state, the icon 504 is grayed out.

At this time, in FIG. 4, the instruction acquirer 403 acquires speaker selection and a voice suppression instruction via a touch panel as the operation input unit 422 of the user terminal 220. The instruction acquirer 403 transmits the speaker selection and the voice suppression instruction to the voice controller 404.

The voice controller 404 controls individual voice data corresponding to the selected speaker and outputs the controlled data to the voice output unit 423 of the user terminal 220. Out of the input voice data 411, individual voice data corresponding to the selected speaker (here, D) is suppressed and output to the voice output unit 423 of the user terminal 220. Identification information of the speaker selected to be suppressed is registered in the speaker database 405.

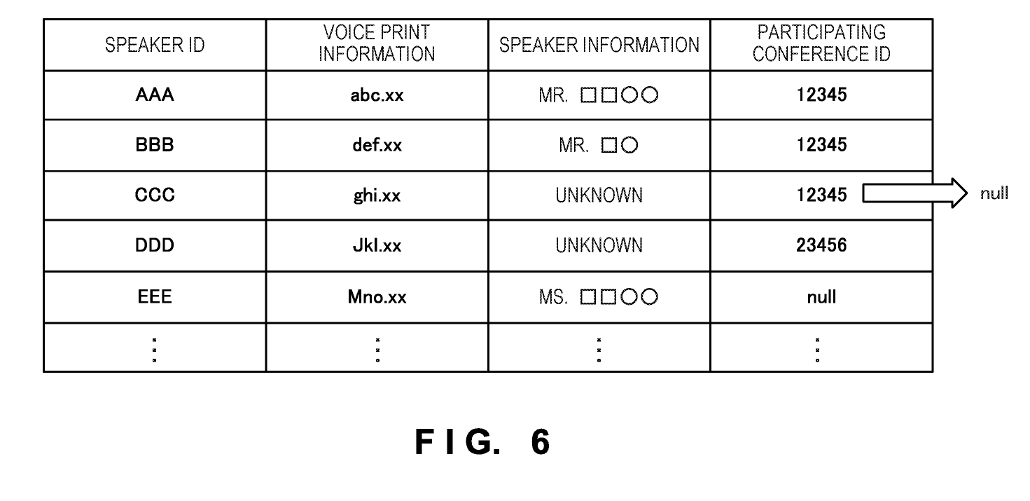

FIG. 6 is a table showing the contents of the speaker database 405. As shown in FIG. 6, the speaker database 405 can register a plurality of pieces of voice print information and personal information in association with each other. The conference voice analyzer 401 can even extract voice print information of conference participants in advance with reference to the speaker database 405. In this case, the speaker notifier 402 may request a user instruction by displaying a message saying “a voice of a speaker other than the conference participants is mixed. Do you want to cut the voice of this speaker?” for the user terminal 220.

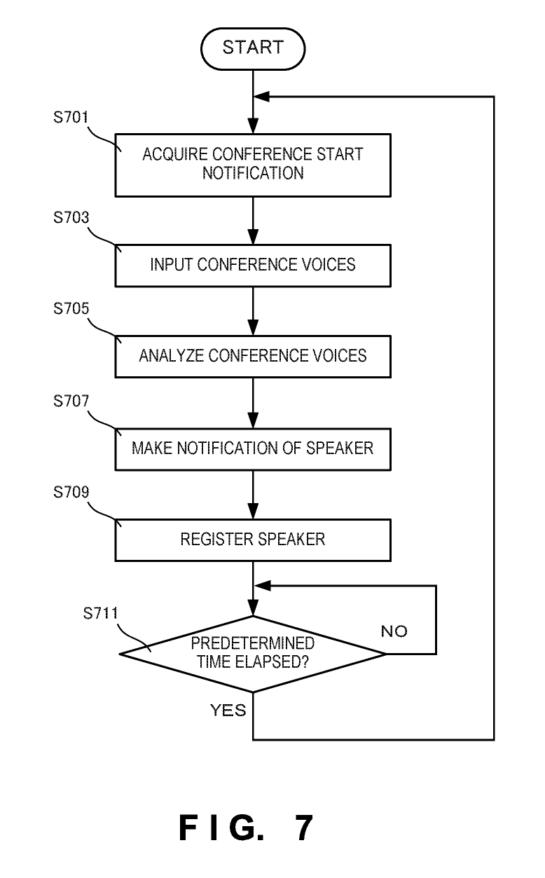

FIG. 7 is a flowchart showing the sequence of voice analysis processing in the conference voice processing apparatus 200. First, when a conference start notification is acquired from the conference voice input terminal 210 in step S701, the input of conference voices is started in step S703. Then, in step S705, the voice print analysis processing is performed on the conference voices (input voice data 411) to extract individual voice data of the speaker.

Then, when the process advances to step S707, the speaker notifier 402 notifies the user terminal 220 of identification information (IDs originally registered in the speaker database 405 in association with voice print information or new IDs) of at least two speakers included in the input voice data 411. Furthermore, in step S709, voice print information of a speaker and the ID of a conference in which the speaker is supposed to be participated are registered in the speaker database 405. For a speaker whose voice print information has already been registered, only the ID of a conference in which the speaker is supposed to be participated is registered. The conference ID here is a conference ID that is linked with the conference voice input terminal 210 in advance.

If it is determined in step S711 that a predetermined time has elapsed, the process returns to step S703 in which a process of inputting and analyzing the conference voices, making the notification of a speaker, and registering the speaker is repeated.

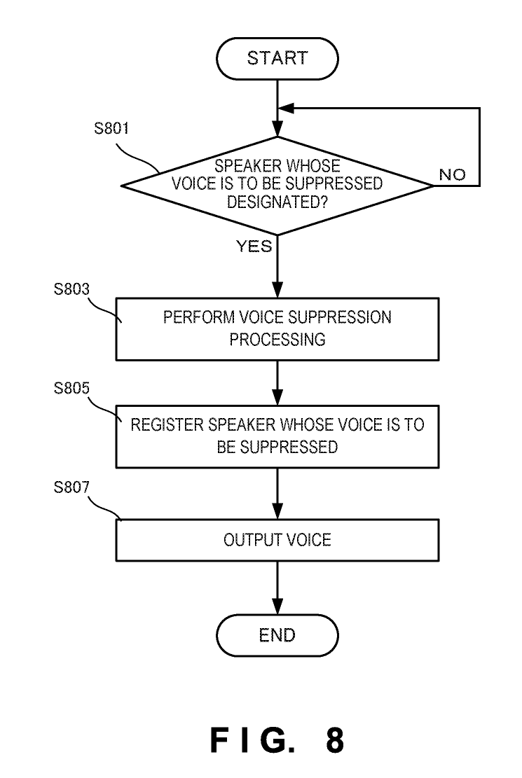

FIG. 8 is a flowchart showing the sequence of voice control processing in the conference voice processing apparatus 200.

In step S801, the instruction acquirer 403 acquires, from the user terminal 220, a selection instruction of at least one speaker included in at least two speakers notified by the speaker notifier 402.

In step S803, the voice controller 404 performs a process of suppressing individual voice data of the selected speaker. Furthermore, in step S805, the instruction acquirer 403 notifies the speaker database 405 of a speaker whose voice is to be suppressed. Regarding the speaker with a notification that his/her voice is to be suppressed, the speaker database 405 changes its participating conference ID to null (for example, a speaker CCC in FIG. 6).

Furthermore, when the process advances to step S807, the voice data that has undergone suppression processing is output to the user terminal 220.

According to the above arrangement, it is possible to control voice data by selecting a speaker who is included in conference voices input from one terminal, making it possible to provide a higher voice quality for a listener of conference contents.

### Third Example Embodiment

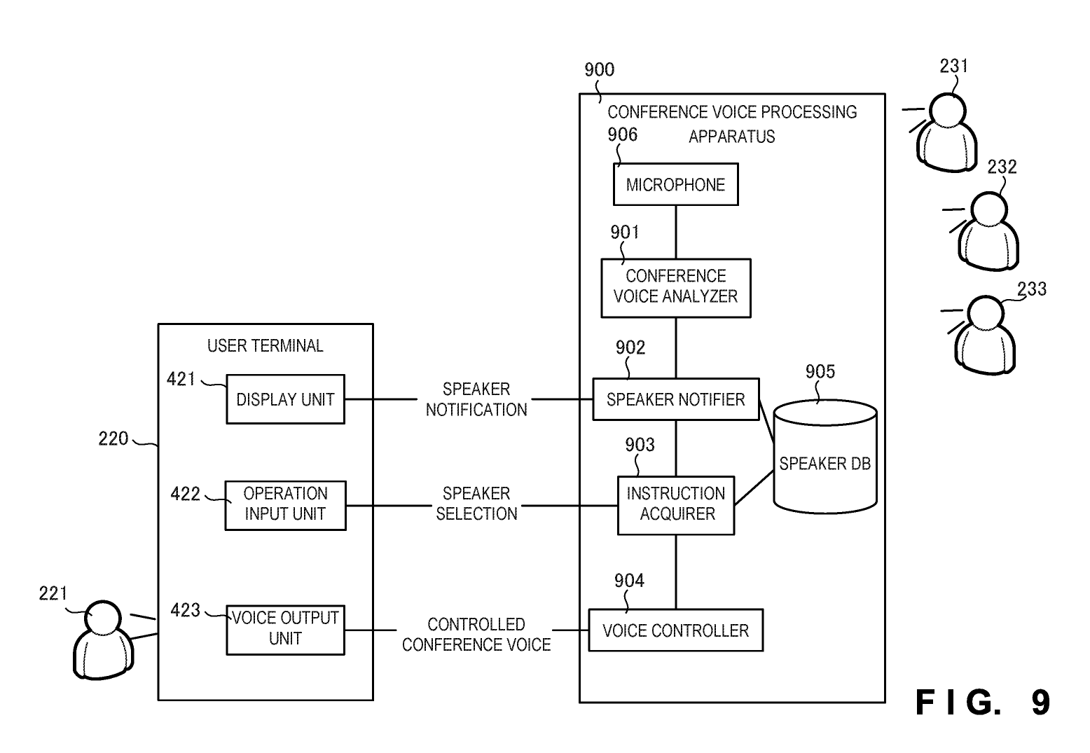

A conference voice processing apparatus according to the third example embodiment of the present invention will be described next with reference to FIG. 9. FIG. 9 is a block diagram for explaining the functional arrangement of a conference voice processing apparatus 900 according to this example embodiment. The conference voice processing apparatus 900 according to this example embodiment is different from that in the above-described second example embodiment in that it includes a microphone used in a conference. Other arrangements and operations are the same as in the second example embodiment, and thus the same reference numerals denote the same arrangements and operations, and a detailed description thereof will be omitted.

The conference voice processing apparatus 900 is, for example, a smartphone owned by a user and is set in the conference. The conference voice processing apparatus 900 includes a conference voice analyzer 901, a speaker notifier 902, an instruction acquirer 903, a voice controller 904, and a speaker database 905 in addition to a microphone 906 and performs information communication with a user terminal 220 via a network.

Voice data in which voices of speakers 231 to 233 acquired by the microphone 906 are mixed is transmitted to the conference voice analyzer 901. The conference voice analyzer 901 performs voice print analysis processing on the input voice data input from the microphone 906 and extracts individual voice data of at least two out of the speakers 231 to 233.

The speaker notifier 902 notifies the user terminal 220 of at least two out of the speakers 231 to 233 included in input voice data 411. The user terminal 220 displays identification images indicating the speakers 231 to 233 on a display unit 421. The speaker notifier 902 notifies the user terminal 220 of the speaker for each predetermined period, and the user terminal 220 updates the identification image on the display unit 421 as needed. Consequently, a speaker who does not utter for a predetermined period or more is no longer displayed. Voice print information of the speaker recognized once is registered in the speaker database 905.

When the instruction acquirer 903 acquires speaker selection and a voice suppression instruction via an operation input unit 422 of the user terminal 220, the instruction acquirer 903 transmits the speaker selection and the voice suppression instruction to a voice controller 404.

The voice controller 404 suppresses individual voice data corresponding to the selected speaker and outputs the suppressed data as a controlled conference voice to a voice output unit 423 of the user terminal 220.

The conference voice analyzer 901, the speaker notifier 902, the instruction acquirer 903, and the voice controller 904 can be implemented by executing an application downloaded to the conference voice processing apparatus 900.

As described above, according to this example embodiment, it is possible to provide a higher voice quality for a listener of conference contents with a simple arrangement.

### Fourth Example Embodiment

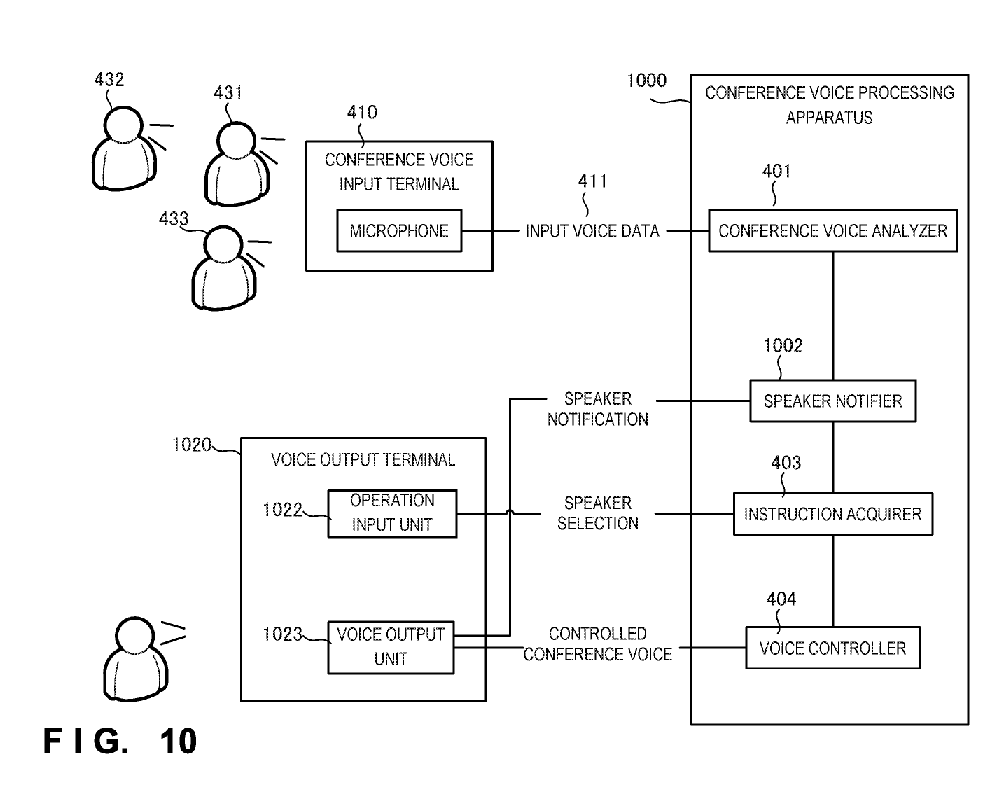

A conference voice processing apparatus according to the fourth example embodiment of the present invention will be described next with reference to FIG. 10. FIG. 10 is a block diagram for explaining the functional arrangement of a conference voice processing apparatus 1000 according to this example embodiment. The conference voice processing apparatus 1000 according to this example embodiment is different from that in the above-described second example embodiment in that a speaker notifier 1002 notifies a voice output terminal 1020 of a speaker by a voice. Other arrangements and operations are the same as in the second example embodiment, and thus the same reference numerals denote the same arrangements and operations, and a detailed description thereof will be omitted.

The voice output terminal 1020 here is a telephone terminal such as a fixed-line telephone without a display unit. In this case, the speaker notifier 1002 notifies the voice output terminal 1020 of a speaker by an identification voice, making it possible to specify a speaker to be suppressed from the voice output terminal 1020. For example, individual voice data for each speaker is reproduced, and a message may be output saying “please dial 1 if you want to turn down the volume of a speaker reproduced first, or dial 2 if you want to turn down the volume of a speaker reproduced next”. Alternatively, when a speaker is specified from a speaker database 405, speaker information may be output in a message saying, for example, “please dial 1 if you want to turn down the volume of Mr. □□ ◯◯”.

### Fifth Example Embodiment

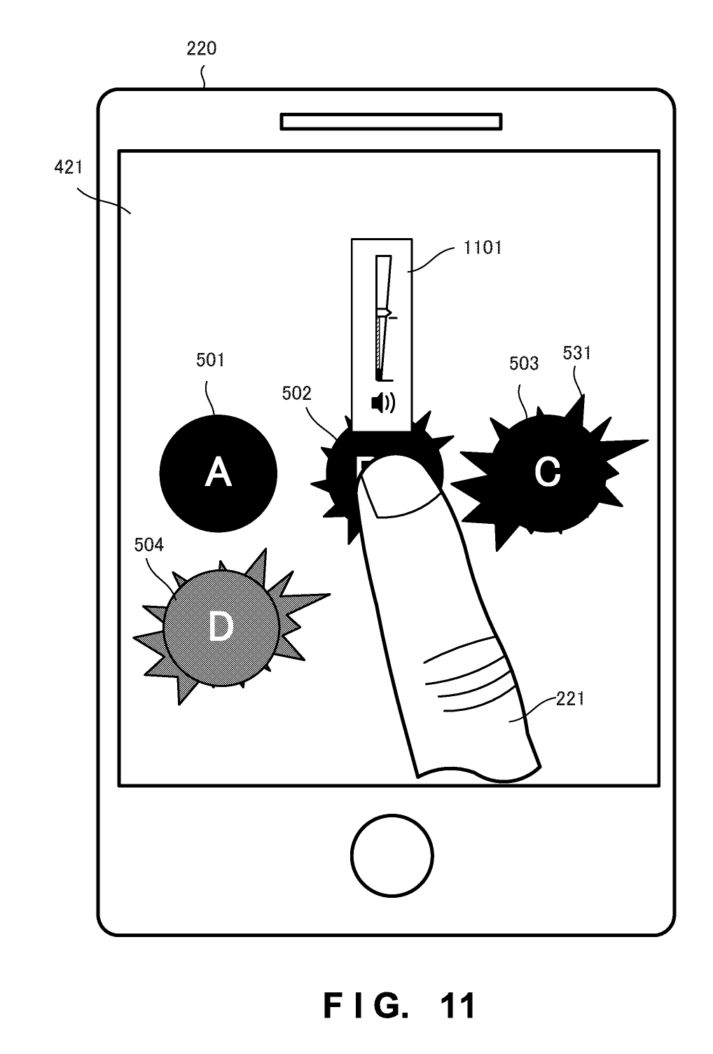

A conference voice processing apparatus according to the fifth example embodiment of the present invention will be described next with reference to FIG. 11. FIG. 11 is a view showing an example of a screen displayed on a user terminal 220 by the conference voice processing apparatus according to this example embodiment. The conference voice processing apparatus according to this example embodiment is different from that in the above-described second example embodiment in that an instruction acquirer acquires a volume at which voice is to be output for each speaker. Other arrangements and operations are the same as in the second example embodiment, and thus the same reference numerals denote the same arrangements and operations, and a detailed description thereof will be omitted.

As shown in FIG. 11, circular icons 501 to 504 are shown as identification images indicating speakers on a display unit 421. If a user 221 taps the icon 502 of B in this state, a volume adjustment bar 1101 is superimposed to accept a volume instruction. A voice controller 404 combines individual voice data at a volume acquired by an instruction acquirer 403 and outputs the combined data to the user terminal 220.

According to the above arrangement, it becomes possible to hear the voice of a specific speaker louder than the voices of other speakers during a conference.

### Sixth Example Embodiment

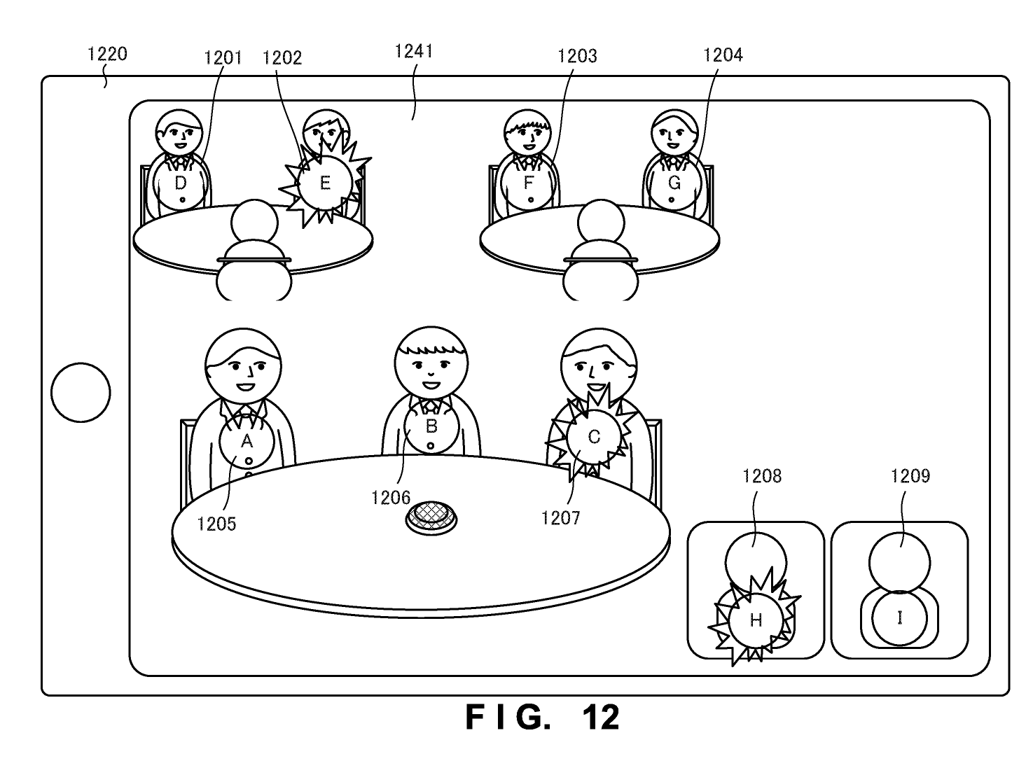

A conference voice processing apparatus according to the sixth example embodiment of the present invention will be described next with reference to FIG. 12. FIG. 12 is a view showing an example of a screen displayed on a user terminal 1220 by the conference voice processing apparatus according to this example embodiment. The conference voice processing apparatus according to this example embodiment is different from that in the above-described second example embodiment in that it acquires a conference video and superimposes speaker identification images on the conference video. Other arrangements and operations are the same as in the second example embodiment, and thus the same reference numerals denote the same arrangements and operations, and a detailed description thereof will be omitted.

As shown in FIG. 12, identification images (circular icons 1201 to 1209) indicating speakers are superimposed on the conference video on a display unit 1241. For persons included in the conference video, the icons 1201 to 1207 are superimposed on images of those persons. If it is determined that persons not included in the video utter, the icons 1208 and 1209 are displayed separately in the right corner of an image. Thus, an arrangement capable of also selecting the persons who do not appear in the video is adopted. If a user 221 taps the icon 1202 of E and the icon 1208 of H in this state, an instruction to suppress voices uttered by E and H is given. A voice controller 404 suppresses individual voice data of a speaker (E) acquired by an instruction acquirer 403, generates conference voice data, and outputs the generated data to a user terminal 220.

According to the above arrangement, a more user-friendly UI can be provided for the user, making it possible to easily suppress the voice of a specific speaker.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above- described example embodiments.

### Other Expressions of Example Embodiments

Some or all of the above-described example embodiments can also be described as in the following supplementary notes but are not limited to the followings.

### (Supplementary Note 1)

There is provided a conference voice processing apparatus, the apparatus comprising:

a conference voice analyzer that extracts individual voice data of at least two speakers from input voice data input from a conference voice input terminal;

a speaker notifier that notifies a user terminal of the at least two speakers included in the input voice data;

an instruction acquirer that acquires, from the user terminal, a selection instruction of at least one speaker included in the at least two speakers notified by said speaker notifier; and

a voice controller that controls individual voice data corresponding to the selected speaker and outputs the controlled data to the user terminal.

### (Supplementary Note 2)

There is provided the apparatus according to supplementary note 1, wherein the user terminal is a communication terminal that includes a display unit, and

said speaker notifier displays identification images that identify the at least two speakers extracted from the input voice data for the user terminal.

### (Supplementary Note 3)

There is provided the apparatus according to supplementary note 1, wherein the user terminal is a telephone terminal that includes a voice output unit, and

said voice notifier outputs an identification voice that identifies the at least two speakers extracted from the input voice data for the user terminal.

### (Supplementary Note 4)

There is provided the apparatus according to supplementary note 1, 2, or 3, wherein said conference voice analyzer extracts individual voice data by performing voice print analysis processing.

### (Supplementary Note 5)

There is provided the apparatus according to supplementary note 4, wherein said speaker notifier outputs speaker identification information with reference to a voice print database that associates a voice print and the speaker identification information with each other.

### (Supplementary Note 6)

There is provided the apparatus according to supplementary note 1, 2, or 3, wherein said conference voice analyzer extracts individual voice data by performing a process of analyzing a sound source direction.

### (Supplementary Note 7)

There is provided the apparatus according to any one of supplementary notes 1 to 6, wherein said voice controller controls the individual voice data corresponding to the selected speaker, mixes the controlled data with individual voice data corresponding to an unselected speaker, and outputs the mixed data to the user terminal.

### (Supplementary Note 8)

There is provided the apparatus according to any one of supplementary notes 1 to 7, wherein said voice controller suppresses the individual voice data corresponding to the selected speaker and outputs the suppressed data to the user terminal.

### (Supplementary Note 9)

There is provided the apparatus according to any one of supplementary notes 1 to 8, wherein said voice controller controls a volume of individual voice data corresponding to the speaker who responds to the selection instruction, and outputs the controlled volume to the user terminal.

### (Supplementary Note 10)

There is provided a conference voice processing apparatus, the apparatus comprising:

a microphone that inputs conference voices;

a conference voice analyzer that extracts individual voice data of at least two speakers from input voice data;

a speaker notifier that notifies a user terminal of the at least two speakers included in the input voice data;

an instruction acquirer that acquires, from the user terminal, a selection instruction of at least one speaker included in the at least two speakers notified by said speaker notifier; and

a voice controller that controls individual voice data corresponding to the selected speaker and outputs the controlled data to the user terminal.

### (Supplementary Note 11)

There is provided a conference voice processing method, the method comprising:

extracting individual voice data of at least two speakers from input voice data input from a conference voice input terminal;

notifying a user terminal of the at least two speakers included in the input voice data;

acquiring, from the user terminal, a selection instruction of at least one speaker included in the at least two speakers notified in the notifying; and

controlling individual voice data corresponding to the selected speaker and outputting the controlled data to the user terminal.

### (Supplementary Note 12)

There is provided the method according to supplementary note 11, wherein the user terminal is a communication terminal that includes a display unit, and

in notifying the user terminal of the at least two speakers, identification images that identify the at least two speakers extracted from the input voice data for the user terminal are displayed.

### (Supplementary Note 13)

There is provided the method according to supplementary note 11, wherein the user terminal is a telephone terminal that includes a voice output unit, and

in notifying the user terminal of the at least two speakers, an identification voice that identifies the at least two speakers extracted from the input voice data for the user terminal is output.

### (Supplementary Note 14)

There is provided the method according to supplementary note 11, wherein in extracting individual voice data of at least two speakers from the input voice data, individual voice data is extracted by performing voice print analysis processing.

### (Supplementary Note 15)

There is provided the method according to supplementary note 14 wherein in notifying the user terminal of the at least two speakers, speaker identification information is output with reference to a voice print database that associates a voice print and the speaker identification information with each other.

### (Supplementary Note 16)

There is provided the method according to supplementary note 11, wherein in extracting individual voice data of at least two speakers from the input voice data, individual voice data is extracted by performing a process of analyzing a sound source direction.

### (Supplementary Note 17)

There is provided the method according to supplementary note 11, wherein in controlling the individual voice data, the individual voice data corresponding to the selected speaker is controlled, the controlled data is mixed with individual voice data corresponding to an unselected speaker, and the mixed data is output to the user terminal.

### (Supplementary Note 18)

There is provided the method according to supplementary note 11, wherein in controlling the individual voice data, the individual voice data corresponding to the selected speaker is suppressed and the suppressed data is output to the user terminal.

### (Supplementary Note 19)

There is provided the method according to supplementary note 11, wherein in controlling the individual voice data, a volume of individual voice data controlled corresponding to the speaker who responds to the selection instruction, and the controlled volume is output to the user terminal.

### (Supplementary Note 20)

There is provided a non-transitory computer readable medium storing a conference voice processing program for causing a computer to execute a method, comprising:

extracting individual voice data of at least two speakers from input voice data input from a conference voice input terminal;

notifying a user terminal of the at least two speakers included in the input voice data;

acquiring, from the user terminal, a selection instruction of at least one speaker included in the at least two speakers notified in the notifying; and

controlling individual voice data corresponding to the selected speaker and outputting the controlled data to the user terminal.

What is claimed is:

1. A conference voice processing apparatus, the apparatus comprising:
a conference voice analyzer that extracts individual voice data of at least two speakers from input voice data input from a conference voice input terminal;
a speaker notifier that notifies a user terminal of the at least two speakers included in the input voice data;
an instruction acquirer that acquires, from the user terminal, a selection instruction of at least one speaker included in the at least two speakers notified by said speaker notifier; and
a voice controller that controls individual voice data corresponding to the selected speaker and outputs the controlled data to the user terminal.

2. The apparatus according to claim 1, wherein the user terminal is a communication terminal that includes a display unit, and
said speaker notifier displays identification images that identify the at least two speakers extracted from the input voice data for the user terminal.

3. The apparatus according to claim 1, wherein the user terminal is a telephone terminal that includes a voice output unit, and
said voice notifier outputs an identification voice that identifies the at least two speakers extracted from the input voice data for the user terminal.

4. The apparatus according to claim 1, wherein said conference voice analyzer extracts individual voice data by performing voice print analysis processing.

5. The apparatus according to claim 4, wherein said speaker notifier outputs speaker identification information with reference to a voice print database that associates a voice print and the speaker identification information with each other.

6. The apparatus according to claim 1, wherein said conference voice analyzer extracts individual voice data by performing a process of analyzing a sound source direction.

7. The apparatus according to claim 1, wherein said voice controller controls the individual voice data corresponding to the selected speaker, mixes the controlled data with individual voice data corresponding to an unselected speaker, and outputs the mixed data to the user terminal.

8. The apparatus according to claim 1, wherein said voice controller suppresses the individual voice data corresponding to the selected speaker and outputs the suppressed data to the user terminal.

9. The apparatus according to claim 1, wherein said voice controller controls a volume of individual voice data corresponding to the speaker who responds to the selection instruction, and outputs the controlled volume to the user terminal.

10. A conference voice processing method, the method comprising:
extracting individual voice data of at least two speakers from input voice data input from a conference voice input terminal;
notifying a user terminal of the at least two speakers included in the input voice data;
acquiring, from the user terminal, a selection instruction of at least one speaker included in the at least two speakers notified in the notifying; and
controlling individual voice data corresponding to the selected speaker and outputting the controlled data to the user terminal.

11. The method according to claim 10, wherein the user terminal is a communication terminal that includes a display unit, and
in notifying the user terminal of the at least two speakers, identification images that identify the at least two speakers extracted from the input voice data for the user terminal are displayed.

12. The method according to claim 10, wherein the user terminal is a telephone terminal that includes a voice output unit, and
in notifying the user terminal of the at least two speakers, an identification voice that identifies the at least two speakers extracted from the input voice data for the user terminal is output.

13. The method according to claim 10, wherein in extracting individual voice data of at least two speakers from the input voice data, individual voice data is extracted by performing voice print analysis processing.

14. The method according to claim 13, wherein in notifying the user terminal of the at least two speakers, speaker identification information is output with reference to a voice print database that associates a voice print and the speaker identification information with each other.

15. The method according to claim 10, wherein in extracting individual voice data of at least two speakers from the input voice data, individual voice data is extracted by performing a process of analyzing a sound source direction.

16. The method according to claim 10, wherein in controlling the individual voice data, the individual voice data corresponding to the selected speaker is controlled, the controlled data is mixed with individual voice data corresponding to an unselected speaker, and the mixed data is output to the user terminal.

17. The method according to claim 10, wherein in controlling the individual voice data, the individual voice data corresponding to the selected speaker is suppressed and the suppressed data is output to the user terminal.

18. The method according to claim 10, wherein in controlling the individual voice data, a volume of individual voice data controlled corresponding to the speaker who responds to the selection instruction, and the controlled volume is output to the user terminal.

19. A non-transitory computer readable medium storing a conference voice processing program for causing a computer to execute a method, comprising:
extracting individual voice data of at least two speakers from input voice data input from a conference voice input terminal;
notifying a user terminal of the at least two speakers included in the input voice data;
acquiring, from the user terminal, a selection instruction of at least one speaker included in the at least two speakers notified in the notifying; and
controlling individual voice data corresponding to the selected speaker and outputting the controlled data to the user terminal.
